(19) United States
(12) Patent Application Publication
(10) Pub. No.: US 2015/0149171 A1
(43) Pub. Date: May 28, 2015

(54) Contextual Audio Recording

(71) Applicants: Andrew Goldman, Beit Shemesh (IL); David Tzvi Springer, Petah Tikva (IL)

(72) Inventors: Andrew Goldman, Beit Shemesh (IL); David Tzvi Springer, Petah Tikva (IL)

(21) Appl. No.: 14/517,967

(22) Filed: Oct. 20, 2014

Related U.S. Application Data
(60) Provisional application No. 61/908,749, filed on Nov. 26, 2013.

(51) Int. Cl. G10L 15/26

(52) U.S. Cl. CPC G10L 15/26
USPC 704/235

(57) ABSTRACT

During a conversation over the network, a microphone attachable to or included in a mobile computer system is used to input audio speech from the user of the computer system. The audio speech is processed into audio speech data. In the audio speech data, the processor monitors for a keyword previously defined by the user. Upon detecting the keyword in the audio speech data, a contextual portion of the audio speech data is extracted including the keyword. The contextual portion of the audio speech data may be converted to text and stored in memory of the computer system or on the network.

### CROSS REFERENCE TO RELATED APPLICATIONS

The present application claims priority from provisional patent application 61/908,749 filed 26 Nov. 2013 in the United States Patent and Trademark Office by the present inventors, the disclosure of which is incorporated herein by reference.

### BACKGROUND

1. Technical Field

The present invention relates to a user interface with computer systems and more specifically a speech interface with the computer system.

2. Description of Related Art

Much of our lives is spent communicating with others at home, in the office or on the road with increased reliance of mobile computer systems sometimes known as “smart-phones”.

In addition to a telephone application, smart-phones are equipped with other applications including, for instance, messaging, electronic mail client, note taking and calendar applications. Often in the course of a conversation over the smart-phone, while using the telephone application, the user of the smart-phone may wish to make a note related to the conversation which may include a name, a telephone number, a meeting date using one of the other available applications. Such an action would normally require, removing the smart-phone from the ear, turning on the speaker so that other party in conversation may be heard, opening the other application on the smart-phone and entering the note using a keyboard application on the touch screen while listening to the other party using the speaker. In the course of these actions, the other party in conversation may not be well heard depending on the level of the background noise and the quality of the speaker. Both parties may need to raise their voices to be heard which may not be appropriate in certain situations. Moreover, the information may be confidential or otherwise sensitive or otherwise the user may not wish to activate the speaker of the smart-phone. The user of the telephone may be otherwise occupied such as driving a motor vehicle and unable to safely interface conventionally with the smart-phone

In these many situations, a pen and paper and/or a good memory may be the preferred prior art solution for recording information spoken during a telephone conversation and storing the information into the smart-phone memory is postponed until a more convenient or appropriate time after the conversation is complete. There is a need for and it would be advantageous to have a method and system for storing information spoken by a user during a telephone conversation.

### BRIEF SUMMARY

Various methods and computer systems performable by a user of the computer system operatively attachable to a network are provided for herein. During a conversation over the network, a microphone attachable to or included in the computer system is used to input audio speech from the user of the computer system to record the audio speech of the user. The audio speech is processed into audio speech data. In the audio speech data, the processor monitors for a keyword which is previously defined by the user of the computer system. Upon detecting the keyword in the audio speech data, a contextual portion of the audio speech data is extracted including the keyword. The keyword may be detected at time t₁ during a time interval initiated by time t₀, and terminated by a time t₂. The contextual portion of the audio speech data occurs in the time interval. The contextual portion of the audio speech data may be converted to text and stored in memory of the computer system or on the network. Similarly, other information may be stored for subsequent search and/or processing including: the audio speech as input, the audio speech data and the contextual portion of the audio speech data, a time stamp of the conversation, an identifier of another party in the conversation. The information stored may be accessible by the user of the computer system subsequent to the conversation.

The monitoring for the keyword may be performed during the processing of the audio speech into the audio speech data or the monitoring for the keyword may be performed subsequent to the processing of the audio speech into the audio speech data.

The time interval may be terminated upon detection of a pause in the audio speech of previously determined time duration and/or terminated upon detection of another keyword or whichever comes first.

The input or recording of audio speech may be performed on audio speech only from the user and not from the other party in the conversation over the network.

An action responsive to either the contextual portion of the audio speech data including the keyword or responsive to the text including the keyword may be performed. The action may be: sending a text message, sending an electronic mail message storing a record in a software application installed in the computer system, activating a remote service and/or posting a message on a server in the network. The processing of the audio speech into the audio speech data, the monitoring for the keyword in the audio speech data, the detection of the keyword and the extraction of a contextual portion of the audio speech data may all be performed by the computer system and not by a server in the network.

The foregoing and/or other aspects will become apparent from the following detailed description when considered in conjunction with the accompanying drawing figures.

### BRIEF DESCRIPTION OF THE DRAWINGS

The invention is herein described, by way of example only, with reference to the accompanying drawings, wherein:

FIG. 1 shows an illustration of a user of a mobile computer system in conversation with another person, according to an embodiment of the present invention.

FIG. 2 illustrates a simplified block diagram of a mobile computer system according to features of the present invention.

FIG. 3 illustrates a flow diagram of a method according to features of the present invention.

FIGS. 3a-3e show various alternatives for timing diagrams showing the extraction of portions of audio speech data, according to various embodiments of the present invention.

The foregoing and/or other aspects will become apparent from the following detailed description when considered in conjunction with the accompanying drawing figures.

### DETAILED DESCRIPTION

Reference will now be made in detail to features of the present invention, examples of which are illustrated in the accompanying drawings, wherein like reference numerals refer to like elements throughout. The features are described below to explain the present invention by referring to the figures.

Before explaining features of the invention in detail, it is to be understood that the invention is not limited in its application to the details of design and the arrangement of the components set forth in the following description or illustrated in the drawings. The invention is capable of other features or of being practised or carried out in various ways. Also, it is to be understood that the phraseology and terminology employed herein is for the purpose of description and should not be regarded as limiting.

By way of introduction, various embodiments of the present invention are directed to record one side of a conversation in which only the speech of the user of a mobile computer system is recorded and not another party or parties participating in the conversation or conference. Software installed in the mobile computer system may monitor for and detect previously trained “keywords” in the recorded speech and if a keyword is found: then speech-to-text conversion may be performed on the context of the user's speech responsive to the keywords detected. The converted text and/or recorded audio may be used later by the user to verify what the user said during the conversation or conference.

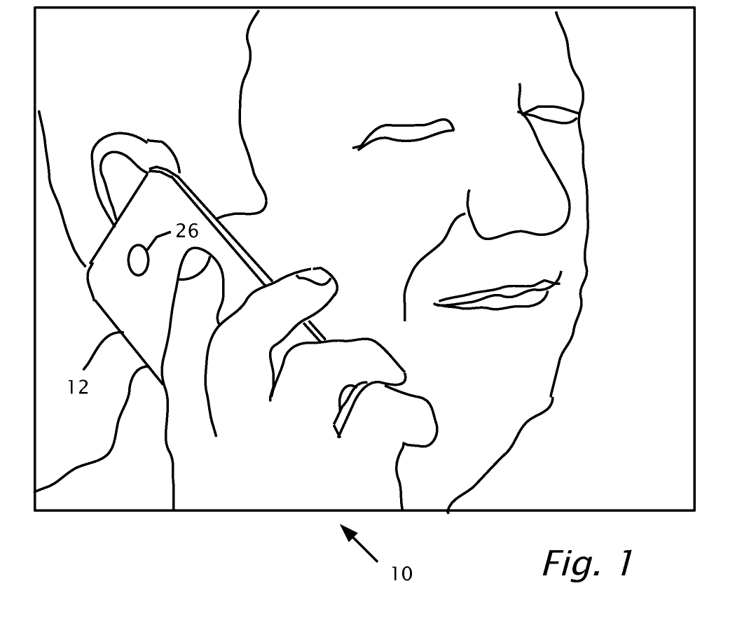

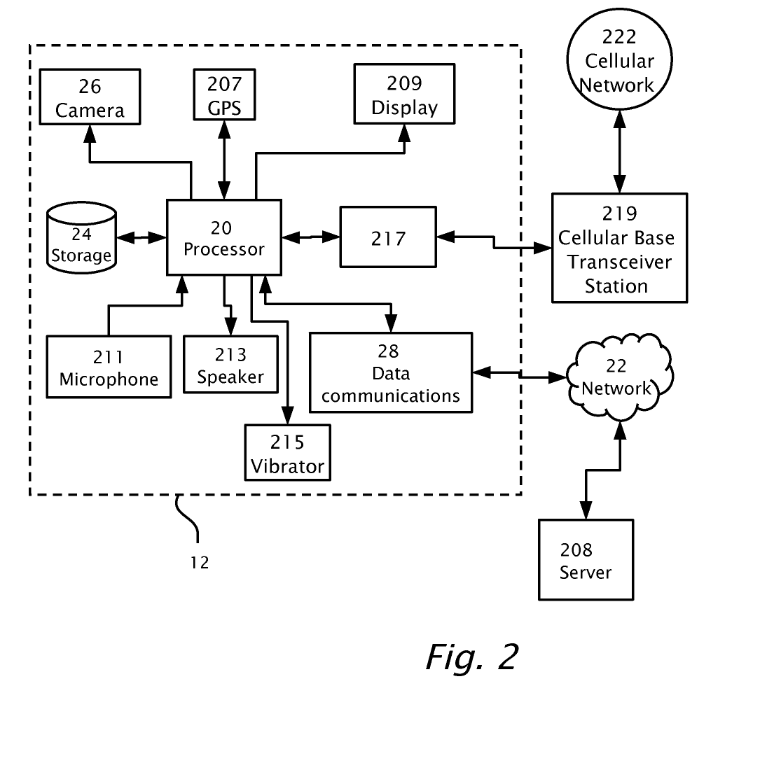

Referring now to the drawings, reference is now made to FIG. 1 which shows an illustration line drawing 10 of a user of a smart-phone or mobile computer system 12 (which shows camera 26) in conversation with another person, according to an embodiment of the present invention. Reference is now also made to FIG. 2 which illustrates a simplified block diagram of mobile computer system 12 according to features of the present invention. Mobile computer system 12 is connectible over a data network 22 to a server 208. Mobile computer system 12 is also connectible through a cellular base station transceiver 219 to the remainder of cellular network 222. Mobile computer system 12 includes a processor 20 connected to local data storage 24. A data communications module 28 connects processor 20 to data network 22. A cellular communications module 217 connects processor 20 to cellular network 222. Mobile computer system 12 may include connected to processor 20, peripheral accessory devices such as a display 209, global positioning system (GPS) 207, camera 26, a microphone 211, a speaker 213, a vibrator 215, accelerometer/gravity sensor, gyroscopic sensor, Blue-tooth™, infra-red sensor (not shown). Mobile computer system 12 may be for example an iPhone™ of Apple Inc., or a smart-phone configured to run an Android™ open operating system.

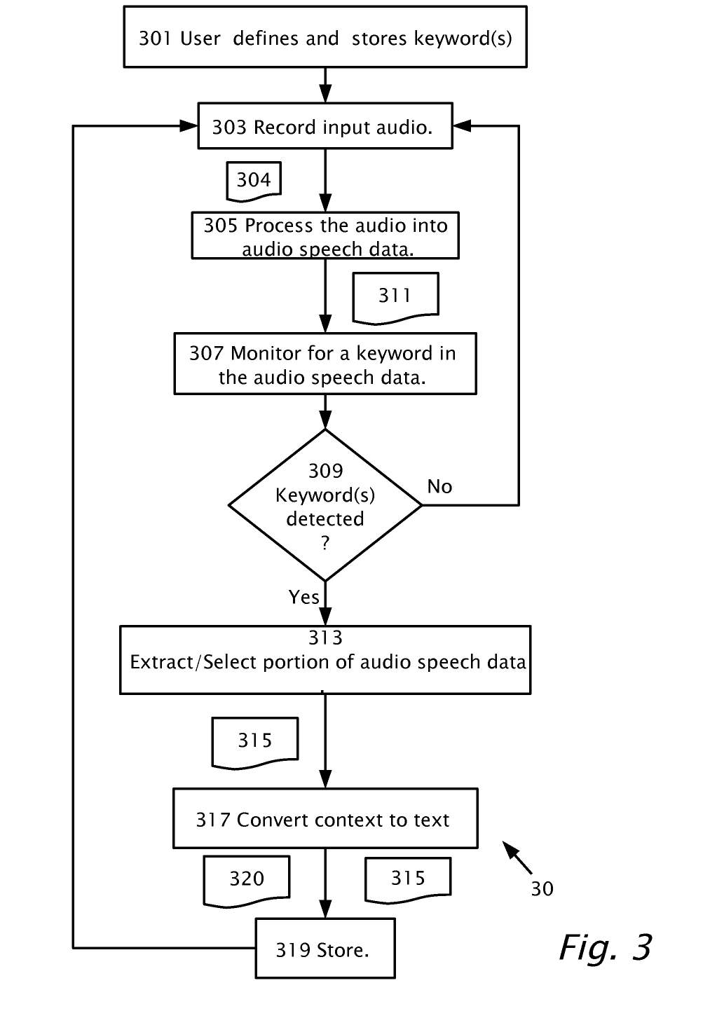

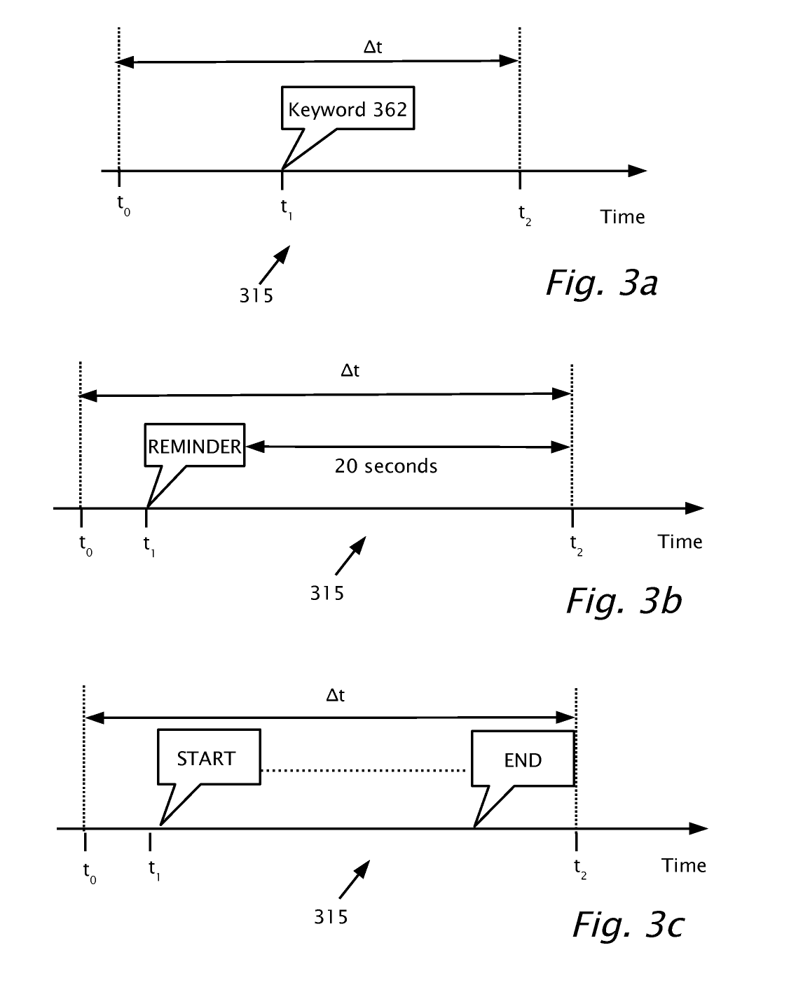

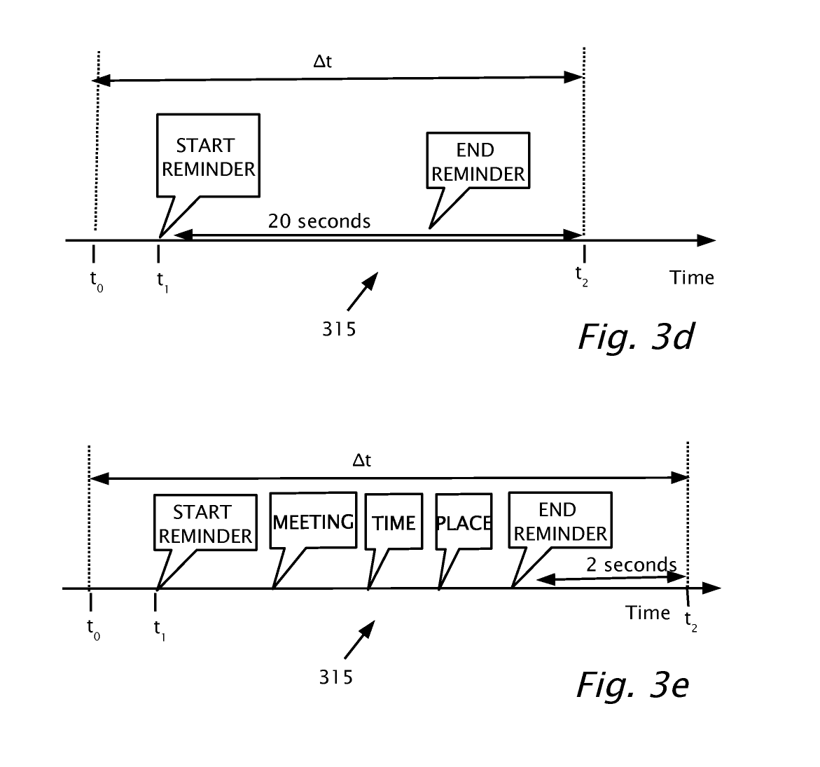

Reference is now made to FIG. 3 which illustrates an exemplary flow diagram of a method 30 according to features of the present invention. In step 301, the user of mobile computer system 12 may define and may store one or more keywords in storage 24 of mobile computer system 12. Step 301 may include the user recording the keyword using microphone 21 and the keyword as input is processed into keyword data which may be stored in step 301.

In the description that follows and drawings, keywords are shown by capital letters.

Keywords may be START and STOP for example. Examples of keywords found in the speech of the user of mobile computer system 12 in a business conversation may be COST, SERVICE and DOLLARS for example.

In step 303, during a conversation over cellular network 222 and/or data network 22, the user of mobile computer system 12 is recorded during the conversation and the recorded audio speech 304 is input using microphone 211 and may be stored in storage 24 of mobile computer system 12.

Software installed on mobile computer system 12 and/or on server 208 allows for the audio input into mobile computer system 12 to be processed in step 305 into audio speech data 311. The processed speech is monitored (step 307) for the keyword. In decision block 309, if the keyword is detected, a portion 315 of the audio speech data 311 including the keyword may be extracted in step 313. Alternatively, if the audio speech data 311 is already partitioned into portions of predetermined time interval Δt, (during steps 303, 305 or 307), portion 315 of the audio speech data 311 is selected which includes the keyword. The extracted or selected portion 315 of audio speech data 311 may include a keyword at time t₁ during a time interval Δt beginning at time t₀ and ending at time t₂. The duration, time interval Δt, of the extracted/selected portion 315 of the audio speech data 311 may be between 2 to 25 seconds for example. Steps 305, 307, 309, 313, 317 and/or 319 may be performed while the conversation is ongoing and/or after the conversation is finished.

In another embodiment of the invention, time interval Δt during which the audio speech data 311 of the user is extracted or selected (step 313) may be initiated by detection of an initiation keyword such as START and terminated by detection of a termination keyword such as STOP or HALT.

In either case, whether a single keyword or multiple keywords are detected (step 309), extracted or selected speech data 315 may be converted (step 317) into text 320 which may be stored (step 319) in storage 24 and/or in server 208.

Alternatively or in addition, the unprocessed recorded audio 304 of the user may be stored (step 319) in storage 24 and/or server 208. Alternatively, portion 315 of speech data may be stored (step 319) in storage 24 and/or server 208 or both extracted speech data 315 and text 320 may be stored (step 319). A time stamp of a conversation and/or an identifier of another party in the conversation may also be stored in step 319.

If a keyword is not detected in decision 309 then audio speech 304 input into mobile computer system 12 via microphone 211 continues with step 303.

The definition and storage of keywords (step 301) may be performed by the user by training a classifier and monitoring and detection steps 307 and 309 respectively may be achieved using the trained classifier. The classifier may use any known technique such as support vector machines (SVM). The definition and storage of keywords (step 301) may involve the user to type a keyword via the keyboard of mobile computer system 12 prior to training the classifier with respect to the keyword, the monitoring and detection steps 307 and 309 respectively.

According to an embodiment of the present invention, method 30 is performed entirely locally by mobile computer system 12.

As an example, in the case of a business conversation where keywords COST, SERVICE and DOLLARS are previously defined (step 301), text 320 may be stored as “The COST of such a SERVICE will be five hundred fifty DOLLARS plus tax”. If the user of mobile computer system 12 does not remember what she quoted in the conversation then she can search easily in stored records 320.

In another example in a conversation where the keywords MEETING, NEXT MONDAY and TIME are detected, text 320 may be stored as “MEETING next MONDAY at 9 AM with Tony Adams”. The keywords may be used as a basis for contextual text 320 to be entered into an application, for instance meeting scheduler, calender, diary, short message service (SMS) software installed on mobile computer system 12. Contextual text 320 may also be entered into a status of the user on social networks which include Facebook™ or Twitter™ where the keywords FACEBOOK and STATUS allows contextual text 320 to be posted on the users Facebook™ time line for example. Where the additional information such as Tony Adams may be derived from the conversion of speech to text directly if the user of mobile computer system 12 is not speaking to Tony Adams because Tony Adam's name is mentioned in the conversation and then converted into text. Alternatively, Tony Adams is the person, the user of mobile computer system 12 is talking to and Tony Adams is derived from the number dialled and phone book of mobile computer system 12. Further on in the conversation the keywords SEND E-MAIL Tony Adams, MEETING and NEXT MONDAY, are detected, contextual text 320 may then be stored as “SEND E-MAIL to Tony Adams, about the MEETING NEXT MONDAY 12/12/2014”.

A further example may be where the keywords enable the activation of a remote service during the phone conversation. The remote service may be activated, for example, when a user is using a vehicle and upon detection of the keywords OPEN GPS, a navigation service/application, e.g. Waze™ opens. Opening of the Waze™ service/application may help the user to navigate a traffic jam or the user needing to change the route being travelled as result of information gained form the phone conversation (e.g. location of a meeting has changed).

Reference is now also made to FIG. 3a which shows a timing diagram including a portion 315 of audio speech data 311, illustrating features of the present invention. Local data storage 24 and/or another storage device located in server 208/cellular network 222 (FIG. 2) may serve as a buffer for recording the input audio 304 or the audio speech data 311. The audio speech data 311 (FIG. 3) may be partitioned into portions of predetermined time interval Δt.

When keyword 362 is detected (decision block 309, FIG. 3) at time t₁, portion 315 including the keyword is selected and optionally adjacent portions before and/or after portion 315 may also be selected from the audio data stream.

Reference is now made to FIG. 3b which shows another timing diagram including portion 315 of audio speech data 311, illustrating other features of the present invention. First keyword REMINDER may be detected during the recording and recording continues for a previously determined additional time interval, e.g. 20 seconds which determines end time t₂ measured from the detection time t₁ of the first keyword.

Reference is now made to FIG. 3c which shows another timing diagram including portion 315 of audio speech data 311, illustrating other features of the present invention. Keyword START is detected in decision block 309 which initiates portion 315 and termination of portion 315 is determined by the further detection of keyword END.

FIG. 3d shows a timing diagram for a time interval Δt, including portion 315 of audio speech data 311, illustrating other features of the present invention. Portion 315 of speech data is initiated at t₁ with keyword START REMINDER and terminates at time t₂ which is previously determined, e.g. 20 seconds after t₁. The additional keywords END REMINDER may be detected during time interval Δt. The time interval Δt may alternatively be terminated upon detection of a sufficiently long previously determined duration of pause in the audio speech 304 of the user.

FIG. 3e shows yet another timing diagram for a time interval Δt, including portion 315 of audio speech data 311, illustrating other features of the present invention. The keywords START REMINDER are detected which initiates portion 315 of audio speech data 311, followed by further detection of keywords MEETING, TIME, PLACE and portion of speech data 315 is terminated at time t₂, two seconds after detection time of the keywords END REMINDER.

The embodiments of the present invention may comprise a general-purpose or special-purpose computer system including various computer hardware components, which are discussed in greater detail below. Embodiments within the scope of the present invention also include computer-readable media for carrying or having computer-executable instructions, computer-readable instructions, or data structures stored thereon. Such computer-readable media may be any available media, which is accessible by a general-purpose or special-purpose computer system. By way of example, and not limitation, such computer-readable media can comprise physical storage media such as RAM, ROM, EPROM, flash disk, CD-ROM or other optical disk storage, magnetic disk storage or other magnetic storage devices, or any other media which can be used to carry or store desired program code means in the form of computer-executable instructions, computer-readable instructions, or data structures and which may be accessed by a general-purpose or special-purpose computer system.

In this description and in the following claims, a “computer system” is defined as one or more software modules, one or more hardware modules, or combinations thereof, which work together to perform operations on electronic data. For example, the definition of computer system includes the hardware components of a personal computer, as well as software modules, such as the operating system of the personal computer. The physical layout of the modules is not important. A computer system may include one or more computers coupled via a computer network. Likewise, a computer system may include a single physical device (such as a phone or Personal Digital Assistant “PDA”) where internal modules (such as a memory and processor) work together to perform operations on electronic data. While any computer system may be mobile, the term “mobile computer system” especially includes laptop computers, net-book computers, cellular telephones, smart-phones, wireless telephones, personal digital assistants, portable computers with touch sensitive screens and the like.

In this description and in the following claims, a “network” is defined as any architecture where two or more computer systems may exchange data. The term “network” may include wide area network, Internet local area network, Intranet, wireless networks such as “Wi-fi”, virtual private networks, mobile access network using access point name (APN) and Internet. Exchanged data may be in the form of electrical signals that are meaningful to the two or more computer systems. When data is transferred or provided over a network or another communications connection (either hard wired, wireless, or a combination of hard wired or wireless) to a computer system or computer device, the connection is properly viewed as a computer-readable medium. Thus, any such connection is properly termed a computer-readable medium. Combinations of the above should also be included within the scope of computer-readable media. Computer-executable instructions comprise, for example, instructions and data which cause a general-purpose computer system or special-purpose computer system to perform a certain function or group of functions.

The term “server” as used herein, refers to a computer system including a processor, data storage and a network adapter generally configured to provide a service over the computer network. A computer system which receives a service provided by the server may be known as a “client” computer system.

The term “contextual” as used herein refers to text and/or audio speech which includes one or more previously defined keywords or portions of the one or more keywords.

The term “audio” or “audio speech” as used herein, refers to sound and/or an analogue electrical signal transduced from the sound.

The term “record” as used herein, refers to a process in which a computer system records the user of the computer system during a conversation over a network. Recording of any other party in conversation over the network may be avoided.

The term “data” as used herein refers to a processed analogue signal, the processing including analogue to digital conversion into digital information accessible to a computer system.

The term “text” as used herein refers to storage of speech as a string of alphanumeric characters after the speech data has successfully been processed into words.

The articles “a”, “an” is used herein, such as “a processor”, “a server”, a “keyword” have the meaning of “one or more” that is “one or more processors”, “one or more servers” and “one or more keywords”.

The present application is gender neutral and personal pronouns ‘he’ and ‘she’ are used herein interchangeably.

Although selected features of the present invention have been shown and described, it is to be understood the present invention is not limited to the described features. Instead, it is to be appreciated that changes may be made to these features without departing from the principles and spirit of the invention, the scope of which is defined by the claims and the equivalents thereof.

What is claimed is:

1. A method performable by a computer system operatively attachable to a network, the method comprising the steps of:
during a conversation over the network, using a microphone attachable to or included in the computer system, inputting audio speech from the user of the computer system, thereby recording the audio speech of the user;
processing said audio speech into audio speech data;
monitoring for a keyword in the audio speech data, wherein the keyword is previously defined by the user of the computer system; and
upon detecting the keyword in the audio speech data, extracting a contextual portion of the audio speech data including the keyword.

2. The method of claim 1, wherein the keyword is detected at time t₁ during a time interval initiated by time t₀, and terminated by a time t₂ and wherein said contextual portion of the audio speech data occurs in said time interval.

3. The method of claim 1, further comprising:
converting to text said contextual portion of the audio speech data; and
storing said text.

4. The method of claim 1, further comprising:
storing information selected from a group consisting of: the audio speech as input, the audio speech data, the contextual portion of the audio speech data, a time stamp of the conversation, an identifier of another party in the conversation wherein the information stored is accessible by the user of the computer system subsequent to the conversation.

5. The method of claim 1, further comprising:
performing said monitoring for said keyword during said processing said audio speech into said audio speech data.

6. The method of claim 1, further comprising:
performing said monitoring for said keyword subsequent to said processing said audio speech into said audio speech data.

7. The method of claim 1, wherein said time interval is selected from the group consisting of:
a time interval of previously determined duration, a time interval terminated upon detection of a pause in the audio speech and a time interval terminated upon detection of another keyword.

8. The method of claim 1, wherein said inputting audio speech is performed on audio speech only from the user and not from the other party in the conversation over the network.

9. The method of claim 1, further comprising the step:
performing an action responsive to said contextual portion of the audio speech data including the keyword, wherein said action is selected from the group consisting of: sending a text message, sending an electronic mail message, storing a record in a software application installed in said computer system and posting a message on a server in the network.

10. The method of claim 1, wherein the steps of : processing said audio speech into said audio speech data, said monitoring for the keyword in the audio speech data, said detecting the keyword and said extracting a contextual portion of the audio speech data are all performed by the computer system and not by a server in the network.

11. A computer system attachable to a network, the computer system operable to:
previously define by the user of the computer system a keyword;
during a conversation over the network, input audio speech from a user of the computer system using a microphone attachable to or included in the computer system to record the audio speech of the user;
process said audio speech into audio speech data;
monitor for said keyword in the audio speech data; and
upon detection of said keyword in the audio speech data, extract a contextual portion of the audio speech data including the keyword.

12. The computer system of claim 11, wherein the computer system is further operable to convert to text said contextual portion of the audio speech data.

13. The computer system of claim 11, wherein the computer system is further operable to
store information selected from a group consisting of: the contextual portion of the audio speech data, the audio speech data, the audio speech, the keyword, the portion of the audio speech data and the text, wherein the information stored is subsequently accessible by the user of the computer system.

14. The computer system of claim 11, wherein only said audio speech of the user is input and processed and not from audio speech from another party in the conversation with the user over the network.

15. The computer system of claim 11, wherein said time interval is selected from the group consisting of: a time interval of previously determined duration and a time interval terminated upon detection of another keyword.

16. The computer system of claim 11, further operable to:
perform an action responsive to said contextual portion of the audio speech data including the keyword, wherein said action is selected from the group consisting of: sending a text message, sending an electronic mail message, storing a record in a software application installed in said computer system, activating a remote service and posting a message on a server in the network.
